(19) United States
(12) Patent Application Publication
(10) Pub. No.: US 2003/0176756 A1
(43) Pub. Date: Sep. 18, 2003

(54) Method of disposing of hazardous wastes connected with criminal activity

(76) Inventor: Larry D. Lewis, Cedar, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/100,325

(22) Filed: Mar. 18, 2002

(51) Int. Cl. A62D 3/00

(52) U.S. Cl. 588/213

(57) ABSTRACT

A method of disposing of hazardous wastes connected with criminal activity comprising transporting a portable incinerator to the site of the criminal activity, sorting through waste materials at the site and selecting waste materials which are combustible and will not emit harmful emissions. The selected waste materials are placed within the incinerator and heated to a temperature of between 1600-1900° F. Non-combustible containers used to practice the illegal activity can be sterilized at the same time. The residue from the incinerator can then be collected and buried in a non-toxic landfill.

### BACKGROUND OF THE INVENTION

The methamphetamine (meth) lab problem is prevalent throughout the United States and the rest of the World. Meth labs used to make the illegal drug are discovered in houses, apartments, motel rooms, sheds, or even motor vehicles. In recent times, Federal, State and Local authorities were involved in the seizure of more than 500 labs in a single state, and the number of such labs seized by law enforcement agencies increases each year.

After a lab is seized by law enforcement officials, professionals trained to handle hazardous materials are generally called in to remove lab wastes and any bulk materials. Some of the chemicals can be disposed of at the site by being mixed with water or other ingredients. However, there are certain chemicals and paraphernalia that must be carefully carried to a special truck or vehicle, and then transported to a far distance point where they are ultimately disposed of in a secluded landfill sometimes located hundreds and hundreds of miles from the site at which they were discovered. The long transportation of these hazardous wastes and materials invites a great problem in the event that any of them would be wrecked, thus creating a dangerous situation wherever such an accident might have taken place.

The cost of loading, transporting, and burying waste materials from typical meth labs can run upwardly of $10,000 per meth lab, and sometimes substantially more.

It is therefore a principal object of this invention to provide a method of disposing of hazardous wastes connected with criminal activity at the site of the activity.

A further object of this invention is to provide a method of disposing of hazardous waste materials connected with criminal activity which is both safe and inexpensive.

These and other objects will be apparent to those skilled in the art.

### SUMMARY OF THE INVENTION

A method of disposing of hazardous wastes connected with criminal activity involves the steps of transporting a portable batch-type incinerator to a site where certain hazardous wastes are located connected to the criminal activity, such as a meth lab site. The next step is identifying the waste materials and sorting through them and selecting waste materials from a group which are combustible in the presence of heat without creating harmful emissions. The selected waste materials are then placed within the incinerator. The incinerator is then heated to a temperature of between 1600-1900° F. for a period of at least one hour and between one hour and two hours to create a particulate residue. The incinerator is then cooled to ambient temperatures, and the residue is collected from the incinerator and put into a portable container. The portable container is then moved from the site and deposited in a convenient local non-toxic landfill. The incinerator is thereupon removed from the site.

### DESCRIPTION OF THE PREFERRED INVENTION

The ingredients and equipment that may be involved in typical meth lab activity include the following:

Pool acid/Muratic acid

Lye

Acetone

Brake Fluid

Brake Cleaner

Iodine Crystals

Lithium Metal/Lithium Batteries

Lighter Fluid

Drain Cleaners (Drano or Liquid Fire)

Cold Medicine Containing Pseudoephedrine (Sudafed)

Ethyl Ether (Starting Fluid)

Anhydrous Ammonia (stored in propane tanks or coolers)

Sodium Metal

Red Phosphorus

Ephedrine

Laboratory Glassware

Coffee Filters

Table Salt

Two Quart Plastic Type Containers for anhydrous ammonia

One gallon metal container or glass container of white gas.

Sludge comprised of a mixture of all the chemicals located in various containers

Various types of glassware used to mix the chemicals

Plastic pop bottles, air tubing and the like

The first step in cleaning up a meth site is to take an inventory of the material at the site and identify the same. At the same time, a portable incinerator pulled behind a pickup truck or the like is brought directly to the site. An incinerator suitable for practicing the method is shown in U.S. Pat. No. 5,339,752, and the drawings and descriptive portion thereof are herein incorporated by reference. Any suitable number of wheels can be applied to the incinerator of U.S. Pat. No. 5,339,752 to enable it to be towed to the site. The incinerator has an after-burner through which emissions from the combusted material are channeled to permit particles in the emissions to be further combusted.

The professionals at the site should then sort through the waste materials and select waste materials from the total group of materials which are combustible in the presence of heat and which can be subjected to heat without creating harmful health emissions. Typical chemicals or utensils that can be subjected to heat would include, without limitation, completed supplies of meth itself which appear as hardened solid particles which are typically smoked. Sludge from the meth manufacturing containers are also collected as combustibles along with such ingredients as Sudafed® and Ephedrine. Equipment which can either be incinerated or at least sterilized would include laboratory glass ware, coffee filters, tubing, and the like. Such components are placed within the incinerator which is then ignited and heated to a temperature of preferably 1600-1900° F. for a period of at least an hour and preferably two hours. The temperature in the after-burner should be 1600° F. or higher. Other components could be the subject of incineration, but harmful emissions might result so they should not be incinerated. For example, iodine crystals, red phosphorous, Lithium, sodium crystals/metals, and lye can be stored in separately labeled Teflon® containers and kept dry for further disposal in accordance with Hazardous Laboratory Chemicals: Disposal Guide: Z28,182-4.

Other harmful components such as anhydrous ammonia can be rendered harmless by being mixed with water under controlled conditions and disposed of at the site. Liquid brake fluid and brake cleaner, for example, can be absorbed by common floor dry and disposed in a landfill. The same would be true for Drano® or acid mixes that have been neutralized by a neutralizer (e.g. baking soda) and which could be mixed with common floor dry to be disposed of in a local landfill.

The metal or other containers placed in the incinerator and subjected to the foregoing conditions of heat will be thoroughly sterilized after the one hour period. The chemicals which have not been vaporized typically will form a fine particulate material which can be taken from the incinerator after it is cooled to ambient temperatures, placed in a suitable container, and transported to a local non-toxic landfill. The incinerator is thereupon towed from the site and is prepared to repeat the activity at the next discovered meth site.

The method of this invention is also useful at other crime scenes where there is a residue of evidence after the law enforcement persons have removed whatever physical evidence is necessary. The incinerator can be brought to such a site and can be used for disposal purposes of residue material whether it be toxic waste or otherwise without having to introduce special toxic waste transporting equipment for transportation to far distant points.

Similarly, the method of this invention can be used at Courthouses and the like after meth or toxic ingredients have completed their function as evidence in a completed criminal case.

It is therefore seen that the method of this invention will permit the swift disposal of many toxic ingredients at a meth lab site or other criminal scene in a very short time, under very safe conditions, and at a very low expense as compared to loading, transporting and then disposing of the same ingredients at a far distant point.

Some of the selected wastes, such as meth, the meth sludge, are preferably combusted at a temperature of between 1100-1300° F. In that case, the incinerator is first heated to that temperature for about one hour, and then the heat is increased to 1600-1900° F. to deal with the remaining selected combustible ingredients.

It is therefore seen that this invention will achieve at least all of its stated objectives.

What is claimed is:

1. A method of disposing of hazardous wastes connected with criminal activity, comprising,
transporting a portable batch-type incinerator to a site where certain hazardous wastes are located connected to criminal activity,
sorting through the waste materials and selecting waste materials from a group which are combustible in the presence of heat without creating harmful health emissions,
placing the selected waste materials within the incinerator,
heating the incinerator to a temperature of between 1600-1900° F. for a period of at least one hour to create a particulate residue,
cooling the incinerator to ambient temperatures,
removing the residue from the incinerator into a portable container,
removing the portable container from the site and depositing the same in a non-toxic landfill, and
removing the portable incinerator from the site.

2. The method of claim 1 wherein the site is a criminal justice building, and the waste is comprised of materials gathered from a crime scene.

3. The method of claim 1 wherein the site is a crime scene and the waste is comprised of wastes not required as evidence for a subsequent investigation or judicial proceeding.

4. The method of claim 1 wherein the site is a meth lab site and the waste is comprised of ingredients and paraphernalia used in the creation of methamphetamine.

5. The method of claim 4 wherein non-combustible paraphernalia are gathered from the site and placed in the incinerator for sterilization purposes.

6. The method of claim 1 wherein the incinerator is heated to a temperature range of 1100° F.-1300° F. for a period of time before being heated to 1600-1900° F. to properly combust certain wastes which are more easily combusted and destroyed at a temperature lower than 1600° F.-1900° F.

7. The method of claim 1 wherein the incinerator has an after-burner through which the emissions from combustion of the selected waste materials are channeled to further combust any particulate material in the emissions.

8. The method of claim 7 wherein the temperature in the after-burner exceeds 1600° F.
